(19) United States
(12) Patent Application Publication
(10) Pub. No.: US 2014/0159524 A1
(43) Pub. Date: Jun. 12, 2014

(54) AUTO CENTERING FITTING SYSTEM FOR THE ASSEMBLY OF ROTATING ELECTRICAL MACHINES AND ROTATING ELECTRICAL MACHINES USING THE SAME

(71) Applicant: WEG EQUIPAMENTOS ELETRICOS S.A. - MOTORES, Jaragua do Sul (BR)

(72) Inventors: Valmir Luis Stoinski, Jaragua do Sul (BR); Rui Paulo Weis, Jaragua do Sul (BR)

(73) Assignee: WEG EQUIPAMENTOS ELETRICOS S.A. - MOTORES, Jaragua do Sul (BR)

(21) Appl. No.: 14/070,791

(22) Filed: Nov. 4, 2013

(30) Foreign Application Priority Data
Dec. 11, 2012 (BR) 10 2012 031595-5

(51) Int. Cl. H02K 5/22

(52) U.S. Cl. CPC H02K 5/22
USPC 310/89; 29/732

(57) ABSTRACT

The present invention discloses an auto centering fitting system for the assembly of rotating electrical machines, comprising a couple of caps (1a) and (1b), wherein said cap (1b) shows a cylindrical geometry, optionally interrupted, comprising a strengthened peripheral region (3b) from which a male-type structure (6) complementary to the channel (4) of the cap (1a) extends longitudinally; and said cap (1a) shows a strengthened region (3a), from which a pair of symmetrical tabs (3c) project distally, which will define a fitting channel (4), forming a junction (5) through the application of axial pressure on both caps in opposite directions to each other, allowing for the fitting of (6) to (4).

### FIELD OF APPLICATION

The present invention patent application discloses an auto centering fitting system applied to rotating electrical machines, comprising cap (bearing) and frame, one of which optionally having a profile with interrupted geometry, allowing for the fitting adjustment between said parts and obviating the need for machining the same.

### FUNDAMENTALS OF THE INVENTION

Among the projects specifications having an impact on the costs, the dimensional tolerance is one of the most significant ones, directly affecting the economic viability in industrial scale. For the smooth operation of a rotating electrical machine, it is necessary to obtain an adequate concentricity between bearings in order to define the rotor and stator positions within tolerable concentricity limits. This condition usually requires good dimensional accuracy of the machine's structural components, such precision being obtained either directly from the processes or, more often, after manufacture with subsequent machining. Currently, the machining step is necessary for the correction of errors that are inherent to the manufacturing processes, since the residual dimensional deviations of the process of manufacturing the components are transmitted to the bearings.

### DESCRIPTION OF STATE OF THE ART

In the state of the art, there are various proposals for the construction of electric motors. U.S. Pat. No. 1,852,829, for example, describes a configuration for small-scale electrical machine stators comprising a breastplate housing a laminated core coupled to the housing in order to decrease sound effects from the vibration between components, presenting a conventional fitting configuration between cap and stator frame of rotating electric machines.

The most common projects exploit the use of parts with flat circular fitting between the two identical and symmetrical caps as is described in U.S. Pat. No. 2,154,146, or between cap and stator, as disclosed in European patent EP0834980, or even more commonly between two caps and a frame surrounding a stator.

Another design is disclosed in patent U.S. Pat. No. 3,476,963, wherein the joining of the two halves of the housing takes place through the interaction of closing elements adjusted on existing cavities on the contact surface. The adjustment of concentricity between the engine components is a critical parameter, and an approach aiming to circumvent the tolerance deviations comprises the use of adapted bearing devices that allow for the adjustment of the clearance between the bushing and the frame. An example is described in JP2008291964, in which it is claimed a rolling bearing provided with a second bushing, which expandable, contractile external surface is kept in contact with a frame provided with a hole overlapping said bushing external surface.

U.S. Pat. No. 5,894,653 in turn describes a method of machining motor frames comprising initially the step of assembly of the motor components and then mounting the rotor shaft on the rear and front caps through couplings in the shape of annular plates. The caps are attached and, after the assembly procedure, the couplings are removed, reducing misalignment of the rotor and stator axes.

However, there are no revealed methods or procedures that allow for the assembly of electrical motors in order to obviate the subsequent step of machining its components in the state of the art. It is noted that a common disadvantage to all relevant projects lies in the fact that these are not auto centering, i.e. dimensional errors in components will impact directly the concentricity parameters between bearings. It should also be noted that the machining methods aimed at this object commonly involve process steps that raise the overall cost of production, not consisting, in this sense, of advantage appropriate for electrical machines, but only a step until then mandatory to achieve the goal of maintaining the concentricity within standards required by electrical sizing.

### OBJECT OF THE INVENTION

In this sense, intending to circumvent the disadvantages related to state of the art, the present invention patent discloses an auto centering fitting system for assembling rotating electrical machines, comprising two caps, one of which shows an interrupted profile, or a cap and a frame, making the system robust to eliminate the machining process and maintain the system with the concentricity required by the project within the admissible margin of error. In another aspect of this invention, it is disclosed a rotating machine electric assembled from the proposed system. In another configuration, the interrupted profile may be replaced by a plurality of fitting segments as observed in

FIGS. 6a and 6b, a condition that also enables the auto adjustment of the diameters, resulting in an auto centering fitting condition.

### BRIEF DESCRIPTION OF FIGURES

FIG. 1 illustrates an assembled and sectioned view of the auto centering fitting system.

FIG. 2 shows a close-up view of the auto centering fitting system.

FIG. 3a illustrates a perspective side view of the complementary cap with inverted profile fit and without the characteristic of an interrupted profile.

FIG. 3b shows a close-up view of the complementary cap with female fit.

FIG. 4a illustrates a perspective view of the cover and its interrupted fit section of the system proposed herein.

FIG. 4b shows a close-up view of the cap comprising the male fit.

FIGS. 5a to 5c illustrate side views of alternative embodiments of the auto centering fitting system proposed herein.

FIGS. 6a and 6b illustrate perspective views of alternative embodiments of the auto centering fitting system formed of a plurality of segments with said fitting profile.

### DETAILED DESCRIPTION OF THE INVENTION

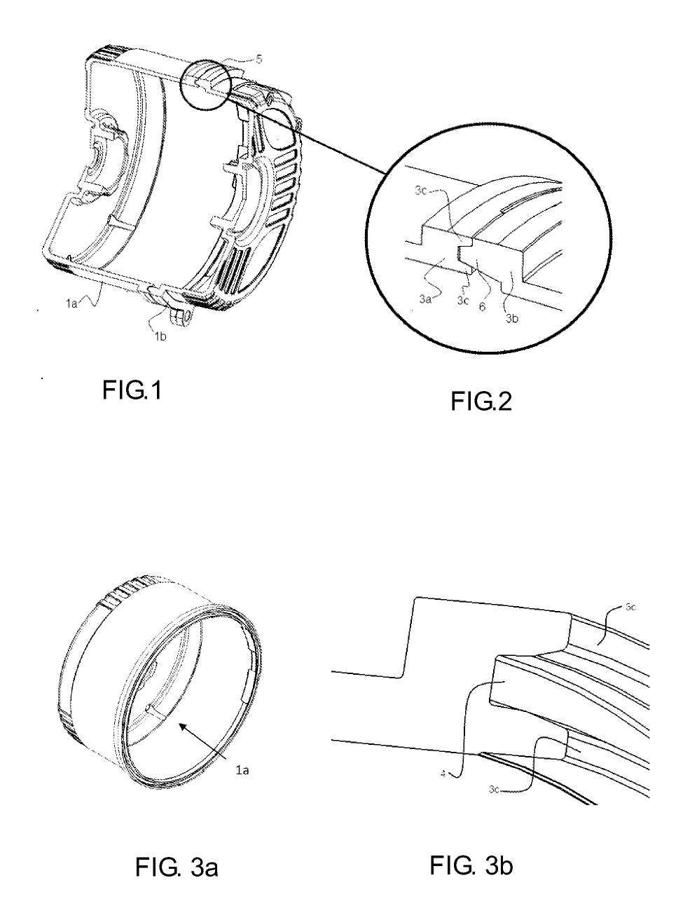

FIG. 1 illustrates a cutaway view of the assembly of the covers from the system proposed herein, comprising a pair of caps (1a) and (1b), of which the junction (5) between the parties is formed with complementary fittings of male/female or even concave/convex type, pressured axially and opposite of each other, both described below.

Considering FIGS. 1 to 3b, the cap (1b) displays a cylindrical geometry comprising a strengthened peripheral region (3b). From the perimeter (3b), a continuous male type structure (6) extends longitudinally, having a geometry that is complementary to the channel (4) of the cap (1a). Considering the close-up view in FIG. 2, it is noted that the cylindrical wall of the cap (1a) shows a strengthened region (3a), from which a pair of symmetrical tabs.(3c) extend distally, which will define the fitting channel (4) as seen in FIG. 3b.

According to FIG. 1, the caps (1a) and (1b) may show approximately equivalent diameters, with allowable variability up to 0.2% for induction motors or up to 0.4% for magnet motors, for example. This is due to the union through the application of closing pressure, in order to allow for the fitting of the structure (6) to the channel (4) in the junction region (5). The interrupted geometry profile of the cap (1b) will enable, within a small limit, the required correction of the difference in circumference between the male and female fittings, always resulting in a proper fit between the parties with regard to concentricity.

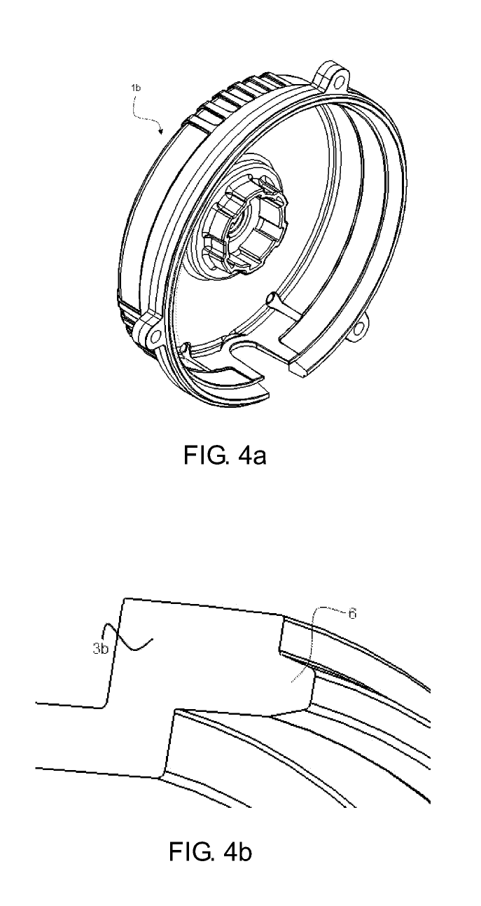

In FIGS. 1, 2, 3a, 3b, 4a, and 4b, the female (1a) and male (1b) fitting profiles of the cap may be observed, the latter provided with an interrupted circular profile. The mechanical locking at the junction (5) of the caps associated with the circular perimeter of one of the interrupted fittings allows for the adjustment of the diameter and, thus, completing the fitting while maintaining good levels of concentricity between both parts (1a) and (1b). One of the fittings presents fixed diameter and the other will be variable. This auto adjustment of the diameter takes place through the interruption of the fitting perimeter of a cap associated with the closing pressure or the assembly of both.

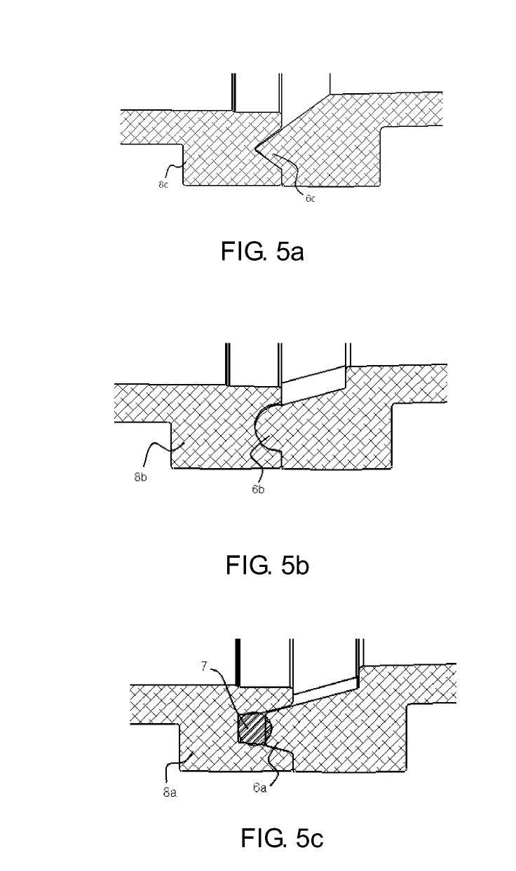

Considering FIGS. 5a, 5b, and 5c, we have alternative embodiments of the fitting profile. In this sense, some constructive possibilities of junction (5) consist of V-shaped (6c and 8c), trapezoidal (6a and 8a), circular (6b and 8b), concave/convex elliptical or any other sort of male-female fitting structures. Optionally, considering FIG. 5c), the proposed system may include a profile element (7), appropriate to the need, having sealing function and placed between the cavity (4) and the structure (6a).

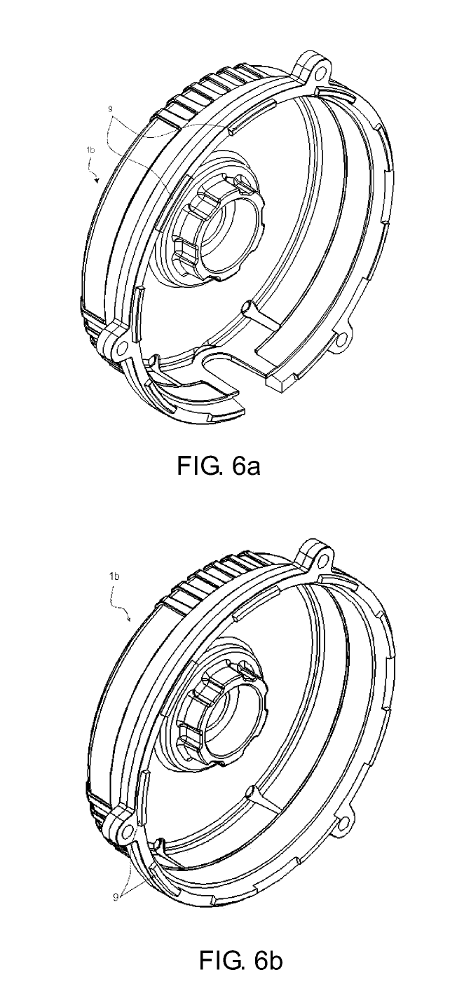

FIGS. 6a and 6b show another constructive possibility, comprising the use of multiple intermittent fitting segments (9), located equidistantly from each other and extending longitudinally from the end of the cover (1b), which will settle in a corresponding channel in the opposite cap (1a). The cap profile (1b) may be interrupted or not interrupted.

It should be noted that the previously indicated terms (namely “caps” and “frames”) should not be construed as limiting or restrictive and other variations comprising similar elements within the scope of the invention claimed herein are possible.

1. An auto centering fitting system for the assembly of rotating electrical machines comprising a couple of caps (1a) and (1b), wherein:
said cap (1b) shows a cylindrical geometry, comprising a strengthened peripheral region (3b) from which a male-type structure (6) complementary to the channel (4) of the cap (1a) extends longitudinally;
said cap (1a) shows a strengthened region (3a), from which a pair of symmetrical tabs (3c) project distally, which will define a fitting channel (4);
wherein a junction (5) is formed through the application of axial pressure on both caps in opposite directions to each other, allowing for the fitting of the structure (6) to the channel (4).

2. The auto centering fitting system for the assembly of rotating electrical machines as defined in claim 1, wherein caps (1a) and (1b) show diameters having variability of up to 0.4% between each other.

3. The auto centering fitting system for the assembly of rotating electrical machines as defined in claim 1, wherein caps (1a) and (1b) show diameters having variability of up to 0.2% between each other.

4. The auto centering fitting system for the assembly of rotating electrical machines as defined in claim 1, wherein the male-female structures (6) show V-shaped (6c), or trapezoidal (6a), or circular (6b), or concave/convex elliptical, or any other sort of male-female complementary fitting profiles.

5. The auto centering fitting system for the assembly of rotating electrical machines as defined in claim 1, wherein the junction (5) between caps (1a) and (1b) optionally include a sealing element (7) placed on the channel (4).

6. The auto centering fitting system for the assembly of rotating electrical machines as defined in claim 1, wherein, in another embodiment, cap (1b) shows a plurality of intermittent fitting segments (9) equidistant from each other and extending longitudinally from the edge of cap (1b).

7. The auto centering fitting system for the assembly of rotating electrical machines as defined in claim 1, wherein the cap profile (1b) optionally shows an interrupted geometry.

8. A rotating electrical machine assembled from the auto centering fitting system, comprising a pair of caps (1a) and (1b), wherein:
said cap (1b) shows a cylindrical geometry, comprising a strengthened peripheral region (3b) from which a male-type structure (6) complementary to the channel (4) of the cap (1a) extends longitudinally;
said cap (1a) shows a strengthened region (3a), from which a pair of symmetrical tabs (3c) project distally, which will define a fitting channel (4);
forming a junction (5) through the fitting of the structure (6) to the channel (4).

9. The rotating electrical machine assembled from the auto centering fitting system as defined in claim 8, wherein caps (1a) and (1b) show diameters having variability of up to 0.2% between each other.

10. The rotating electrical machine assembled from the auto centering fitting system as defined in claim 8, wherein caps (1a) and (1b) show diameters having variability of up to 0.4% between each other.

11. The rotating electrical machine assembled from the auto centering fitting system as defined in claim 8, wherein the male-female structures (6) show V-shaped (6c), or trapezoidal (6a), or circular (6b), or concave/convex elliptical, or any other sort of male-female complementary fitting profiles.

12. The rotating electrical machine assembled from the auto centering fitting system as defined in claim 8, wherein the junction (5) between caps (1a) and (1b) optionally include a sealing element (7) placed on the channel (4).

13. The rotating electrical machine assembled from the auto centering fitting system as defined in claim 8, wherein, in another embodiment, cap (1b) shows a plurality of intermittent fitting segments (9) equidistant from each other and extending longitudinally from the edge of cap (1b).

14. The rotating electrical machine assembled from the auto centering fitting system as defined in claim 8, wherein the cap profile (1b) optionally shows an interrupted geometry.

15. An auto centering fitting system for the assembly of rotating electrical machines as defined in claim 2, wherein caps (1a) and (1b) show diameters having variability of up to 0.2% between each other.

16. The auto centering fitting system for the assembly of rotating electrical machines as defined in claim 2, wherein the junction (5) between caps (1a) and (1b) optionally include a sealing element (7) placed on the channel (4).

17. The auto centering fitting system for the assembly of rotating electrical machines as defined in claim 3, wherein the junction (5) between caps (1a) and (1b) optionally include a sealing element (7) placed on the channel (4).

18. The rotating electrical machine assembled from the auto centering fitting system as defined in claim 9, wherein caps (1a) and (1b) show diameters having variability of up to 0.4% between each other.

19. The rotating electrical machine assembled from the auto centering fitting system as defined in claim 9, wherein the junction (5) between caps (1a) and (1b) optionally include a sealing element (7) placed on the channel (4).

20. The rotating electrical machine assembled from the auto centering fitting system as defined in claim 10, wherein the junction (5) between caps (1a) and (1b) optionally include a sealing element (7) placed on the channel (4).

21. The rotating electrical machine assembled from the auto centering fitting system as defined in claim 11, wherein the junction (5) between caps (1a) and (1b) optionally include a sealing element (7) placed on the channel (4).
